(19) United States
(12) Patent Application Publication
(10) Pub. No.: US 2013/0253954 A1
(43) Pub. Date: Sep. 26, 2013

(54) SYSTEM AND METHOD FOR MANAGING CASE DATABASE

(71) Applicants: FUJIFILM CORPORATION, Tokyo (JP); SHIZUOKA PREFECTURE, Shizuoka (JP)

(72) Inventors: Keiji Sugihara, Tokyo (JP); Masahiro Endo, Shizuoka (JP)

(73) Assignees: SHIZUOKA PREFECTURE, Shizuoka (JP); FUJIFILM Corporation, Tokyo (JP)

(21) Appl. No.: 13/848,661

(22) Filed: Mar. 21, 2013

(30) Foreign Application Priority Data
Mar. 23, 2012 (JP) 2012-067601

(51) Int. Cl. G06F 19/00; G06Q 50/24

(52) U.S. Cl. CPC G06F 19/322; G06Q 50/24
USPC 705/3

(57) ABSTRACT

There is provided a system and method for managing a case database that can enhance the quality of information to be registered. Once a user performs an operation to request registration of a case, it is first searched whether or not a case that can be determined to be similar to the case has already been registered in a case database. A result of the search is then reported, while executable processing options determined based on the result of the search are also reported. If the case that can be determined to be similar has already been registered, the executable processing options include processing of registering as a new case, processing of registering by adding into an existing case, and processing of cancelling registration. If the case that can be determined to be similar has not been registered, the executable processing options include processing of registering as a new case and processing of cancelling registration. The user selects processing to be executed out of the reported executable processing options. Accordingly, only the cases truly needed by the user can be registered into the case database.

### BACKGROUND OF THE INVENTION

1. Field of the Invention

The present invention relates to a system and method for managing a case database, and more particularly relates to a system and method for managing a case database in which case information including a case image and diagnostic information on the case image is registered into the case database.

2. Description of the Related Art

In a medical field, images obtained by modalities, such as X-ray plain radiography devices and CT (Computed Tomography), MR (Magnetic Resonance), PET (Positron Emission Tomography) and ultrasonic photography devices, are indicated on a display, and observation (diagnostic reading) of shadows in the images is performed to diagnose the presence, type and state of diseases. As a function to support such a diagnosis, there are provided for use in diagnostic reading, a function of extracting, out of case information registered into a database, information on a case having features similar to those of an image obtained by an examination and a function of displaying the extracted information as reference information for use in diagnosis.

For example, Japanese Patent Application Laid-Open No. 2002-230518 discloses a device adapted to extract a lesion position from a diagnosing image, calculate a feature value that expresses a radiographic feature of the extracted lesion position, collate feature values of reference images accumulated in the database with the feature value of the diagnosing image so as to obtain similarity degrees of the reference images with respect to the diagnosing image, display the reference images with high similarity degrees, and to further display information such as findings about these reference images with high similarity degrees.

In such a device, it is necessary to register only the information, which is valuable enough to be referred as case information, into a database so as to prevent misdiagnosis.

Accordingly, in Japanese Patent Application Laid-Open No. 2008-234309, it is proposed to register into a database only the case information on the case which has received a definite diagnosis (a final diagnosis as a result of a plurality of diagnoses made according to a plurality of diagnosing methods or by a plurality of doctors, such as a diagnosis based on the result of biopsy and a diagnosis made by a doctor who is authorized to make a final determination).

However, in the case of Japanese Patent Application Laid-Open No. 2008-234309, the information on the cases that received a definite diagnosis is all registered into the database, and so the registered information includes those not truly needed by a user. As a result, the quality of the case information registered into the database may disadvantageously be deteriorated. Moreover, the cases already registered may disadvantageously be registered in a repeated manner.

The present invention has been made in view of such circumstances, and an object of the present invention is to provide a system and method for managing a case database that can enhance the quality of information to be registered.

### SUMMARY OF THE INVENTION

The solution to the above-stated problems is as shown below.

A first aspect of a system for managing a case database includes: a case database adapted to have case information, including a case image and diagnostic information on the case image, registered therein per case; a registration instructing device adapted to instruct registration of case information into the case database; a similar case search device adapted to search the case database for a case that can be determined to be similar to a case of the case information instructed to be registered by the registration instructing device; a search result reporting device adapted to report a search result by the similar case search device; an executable processing reporting device adapted to report executable processing options based on the search result by the similar case search device; an execution processing selecting device adapted to receive a selection of the executable processing options reported by the executable processing reporting device; and a processing executing device adapted to execute the processing selected by the execution processing selecting device.

According to this aspect, once a user instructs case information registration, the presence of a case that can be determined to be similar to the case of the case information is searched. The search result is then reported, while executable processing options based on the search result are also reported. The user selects, out of the reported executable processing options, processing to be executed. Once the processing to be executed is selected, the selected processing is executed. Accordingly, when the case information instructed to be registered has already been registered for example, it becomes possible to cancel registration, to register the information as a new separate case, or to add the information to an existing case, so that the user can register only the truly needed information. This makes it possible to enhance the quality of information to be registered. Moreover, since executable processing options based on the search result are reported, and the processing to be executed is selected out of the reported processing options, a user-friendly system can be configured.

A second aspect of the system for managing a case database is an aspect according to the first aspect, wherein the search result reporting device reports a case retrieved by the similar case search device as the search result.

According to this aspect, a case retrieved as the case that can be determined to be similar is reported as the search result. As a result, it becomes possible to grasp not only the presence of the case that can be determined to be similar but also each of the retrieved cases.

A third aspect of the system for managing a case database is an aspect according to the second aspect, further including a case information output device adapted to output case information on the case retrieved by the similar case search device.

According to this aspect, case information on the case retrieved as the case that can be determined to be similar is outputted. As a result, it becomes possible to grasp the detail of the retrieved case.

A fourth aspect of the system for managing a case database is an aspect according to the third aspect, further including a case selecting device adapted to select, out of cases reported by the search result reporting device, a case for case information output, wherein the case information output device outputs case information on the case selected by the case selecting device.

According to this aspect, when a plurality of cases are retrieved as the case that can be determined to be similar, it becomes possible to select a case for case information output out of these retrieved cases. As a consequence, it becomes possible to grasp the detail of only a desired case and to thereby configure a user-friendly system.

A fifth aspect of the system for managing a case database is an aspect according to any one of the first to fourth aspects, wherein when a case that can be determined to be similar to the case of the case information instructed to be registered by the registration instructing device is retrieved by the similar case search device, the executable processing reporting device reports, as the executable processing options, processing of registering as a new case the case of the case information instructed to be registered by the registration instructing device and processing of cancelling registration of the case of the case information instructed to be registered by the registration instructing device.

According to this aspect, when a case that can be determined to be similar to the case of the case information instructed to be registered is retrieved, processing of registering as a new case the case of the case information instructed to be registered and processing of cancelling registration of the case of the case information instructed to be registered are selectably reported as executable processing options. As a consequence, it becomes possible to eliminate useless registration and to register only the truly needed cases.

A sixth aspect of the system for managing a case database is an aspect according to any one of the first to fourth aspects, wherein when a case that can be determined to be similar to the case of the case information instructed to be registered by the registration instructing device is retrieved by the similar case search device, the executable processing reporting device reports, as the executable processing options, processing of registering as a new case the case of the case information instructed to be registered by the registration instructing device, processing of cancelling registration of the case of the case information instructed to be registered by the registration instructing device, and processing of adding to the case retrieved by the similar case search device the case information instructed to be registered by the registration instructing device.

According to this aspect, when a case that can be determined to be similar to the case of the case information instructed to be registered is retrieved, processing of registering as a new case the case of the case information instructed to be registered, processing of cancelling registration of the case of the case information instructed to be registered, and processing of adding to the retrieved case the case information instructed to be registered are selectably reported as the executable processing options. As a consequence, it becomes possible to eliminate useless registration and to register only the truly needed cases.

A seventh aspect of the system for managing a case database is an aspect according to the fourth aspect, wherein when a case that can be determined to be similar to the case of the case information instructed to be registered by the registration instructing device is retrieved by the similar case search device, the executable processing reporting device reports, as the executable processing options, processing of registering as a new case the case of the case information instructed to be registered by the registration instructing device, processing of cancelling registration of the case of the case information instructed to be registered by the registration instructing device, and processing of adding to the case retrieved by the similar case search device the case information instructed to be registered by the registration instructing device, and when the processing of adding to the case retrieved by the similar case search device the case information instructed to be registered by the registration instructing device is selected by the execution processing selecting device, the processing executing device adds to the case selected by the case selecting device the case information instructed to be registered by the registration instructing device.

According to this aspect, when a case that can be determined to be similar to the case of the case information instructed to be registered is retrieved, the processing of registering as a new case the case of the case information instructed to be registered, the processing of cancelling registration of the case of the case information instructed to be registered, and the processing of adding to the retrieved case the case information instructed to be registered are selectably reported as the executable processing options. Moreover, when a plurality of cases that can be determined to be similar to the case of the case information instructed to be registered are retrieved, and the processing of adding to the retrieved case the case information instructed to be registered is selected as the executable processing, a case to which the case information is added can be selected. As a consequence, it becomes possible to appropriately add case information to a desired case and to thereby construct a high quality system.

An eighth aspect of the system for managing a case database is an aspect according to any one of the fifth to seventh aspects, wherein when a case that can be determined to be similar to the case of the case information instructed to be registered by the registration instructing device is not retrieved by the similar case search device, the executable processing reporting device reports, as the executable processing options, processing of registering as a new case the case of the case information instructed to be registered by the registration instructing device and processing of cancelling registration of the case of the case information instructed to be registered by the registration instructing device.

According to this aspect, when a case that can be determined to be similar to the case of the case information instructed to be registered is not retrieved, the processing of registering as a new case the case of the case information instructed to be registered and the processing of cancelling registration of the case of the case information instructed to be registered are selectably reported as the executable processing options. As a consequence, it becomes possible to eliminate useless registration and to register only the truly needed cases.

A ninth aspect of the system for managing a case database is an aspect according to any one of the first to eighth aspects, further including a search condition setting device adapted to set conditions for the similar case search device to determine the case to be similar.

According to this aspect, it becomes possible to set conditions to determine the case to be similar. This makes it possible to register only the truly needed cases according to the policy of each system.

A tenth aspect of the system for managing a case database is an aspect according to any one of the first to ninth aspects, further including: a case search device adapted to search the case database by using a case image or diagnostic information as a search query; and an output device adapted to output a case retrieved by the case search device.

According to this aspect, the information registered in the case database can be retrieved by using a case image or diagnostic information as a search query. If case information is added to the retrieved case during their registration process, then the added case information is also outputted. Accordingly, it becomes possible to comprehensively obtain the truly needed information and to thereby configure a user-friendly system.

A first aspect of a method for managing a case database includes: a step of instructing registration of case information, including a case image and diagnostic information on the case image, into a case database; a step of searching the case database for a case that can be determined to be similar to a case of the case information instructed to be registered; a step of reporting a result of the search; a step of reporting executable processing options based on the result of the search; a step of receiving selected processing to be executed out of the reported executable processing options; and a step of executing the selected processing.

According to this aspect, once a user instructs case information registration, the presence of a case that can be determined to be similar to the case of the case information is searched. The search result is then reported, while executable processing options are also reported based on the search result. The user selects, out of the reported executable processing options, processing to be executed. Once the processing to be executed is selected, the selected processing is executed. Accordingly, when the case information instructed to be registered is the information already registered for example, it becomes possible to cancel the registration, to register the information as a new separate case, or to add the information to an existing case, so that the user can register only the truly needed information. This makes it possible to enhance the quality of information to be registered. Moreover, since executable processing options are reported based on the search result, and processing to be executed is selected out of the reported processing options, a user-friendly system can be configured.

A second aspect of the method for managing a case database is an aspect according to the first aspect, wherein in the step of reporting the result of the search, the retrieved case is reported.

According to this aspect, a case retrieved as the case that can be determined to be similar is reported as the search result. As a result, it becomes possible to grasp not only the presence of the case that can be determined to be similar but also each of the retrieved cases.

A third aspect of the method for managing a case database is an aspect according to the second aspect, further including a step of outputting case information on the retrieved case.

According to this aspect, case information on the case retrieved as the case that can be determined to be similar is outputted. As a result, it becomes possible to grasp the detail of the retrieved case.

A fourth aspect of the method for managing a case database is an aspect according to the third aspect, further including a step of receiving a case selected for case information output out of the reported cases, wherein in the step of outputting the case information on the retrieved case, case information on the selected case is outputted.

According to this aspect, when a plurality of cases are retrieved as the case that can be determined to be similar, it becomes possible to select a case for case information output out of these retrieved cases. As a consequence, it becomes possible to grasp the detail of only a desired case and to thereby configure a user-friendly system.

A fifth aspect of the method for managing a case database is an aspect according to any one of the first to fourth aspects, wherein in the step of reporting executable processing options based on the result of the search, processing of registering as a new case the case of the case information instructed to be registered and processing of cancelling registration of the case of the case information instructed to be registered are reported as the executable processing options.

According to this aspect, when a case that can be determined to be similar to the case of the case information instructed to be registered is retrieved, processing of registering as a new case the case of the case information instructed to be registered and processing of cancelling registration of the case of the case information instructed to be registered are selectably reported as executable processing options. As a consequence, it becomes possible to eliminate useless registration and to register only the truly needed cases.

A sixth aspect of the method for managing a case database is an aspect according to any one of the first to fourth aspects, wherein in the step of reporting executable processing options based on the result of the search, processing of registering as a new case the case of the case information instructed to be registered, processing of cancelling registration of the case of the case information instructed to be registered, and processing of adding to the retrieved case the case information instructed to be registered are reported as the executable processing options.

According to this aspect, when a case that can be determined to be similar to the case of the case information instructed to be registered is retrieved, processing of registering as a new case the case of the case information instructed to be registered, processing of cancelling registration of the case of the case information instructed to be registered, and processing of adding to the retrieved case the case information instructed to be registered are selectably reported as the executable processing options. As a consequence, it becomes possible to eliminate useless registration and to register only the truly needed cases.

A seventh aspect of the method for managing a case database is an aspect according to the fourth aspect, wherein in the step of reporting executable processing options based on the result of the search, processing of registering as a new case the case of the case information instructed to be registered, processing of cancelling registration of the case of the case information instructed to be registered, and processing of adding to the retrieved case the case information instructed to be registered are reported as the executable processing options, and in the step of executing the selected processing, if the processing of adding to the retrieved case the case information instructed to be registered is selected as the executable processing, the case information instructed to be registered is added to the case selected for case information output.

According to this aspect, when a case that can be determined to be similar to the case of the case information instructed to be registered is retrieved, processing of registering as a new case the case of the case information instructed to be registered, processing of cancelling registration of the case of the case information instructed to be registered, and processing of adding to the retrieved case the case information instructed to be registered are selectably reported as the executable processing options. Moreover, when a plurality of cases that can be determined to be similar to the case of the case information instructed to be registered are retrieved, and the processing of adding to the retrieved case the case information instructed to be registered is selected as the executable processing, a case to which the case information is added can be selected. As a consequence, it becomes possible to appropriately add case information to a desired case and to thereby construct a high quality system.

An eighth aspect of the method for managing a case database is an aspect according to any one of the fifth to seventh aspects, wherein in the step of reporting executable processing options based on the result of the search, processing of registering as a new case the case of the case information instructed to be registered by the registration instructing device and processing of cancelling registration of the case of the case information instructed to be registered by the registration instructing device are reported as the executable processing options.

According to this aspect, when a case that can be determined to be similar to the case of the case information instructed to be registered is not retrieved, processing of registering as a new case the case of the case information instructed to be registered and processing of cancelling registration of the case of the case information instructed to be registered are selectably reported as the executable processing options. As a consequence, it becomes possible to eliminate useless registration and to register only the truly needed cases.

A ninth aspect of the method for managing a case database is an aspect according to any one of the first to eighth aspects, further including a step of setting conditions to determine the case to be similar.

According to this aspect, it becomes possible to set conditions to determine the case to be similar. This makes it possible to register only the truly needed cases according to the policy of each system.

According to the present invention, it becomes possible to register only the truly needed information and to thereby enhance the quality of the information registered into a database.

### BRIEF DESCRIPTION OF THE DRAWINGS

FIG. 1 is a system configuration view showing the schematic configuration of a case management system with the present invention applied thereto;

FIG. 2 is a system configuration view showing the schematic configuration of a medical examination system;

FIG. 3 is a view showing the configuration of the case management system of FIG. 1 with an emphasis being given to functions of case registration and access thereto;

FIG. 4 is a flow chart showing procedures of case registration;

FIG. 5 is a view showing one example of a display indication when there are cases that can be determined to be similar;

FIG. 6 is a view showing one example of a display indication when there is no case that can be determined to be similar;

FIG. 7 is a view showing one example of case information generated by a case information registration section;

FIG. 8 is a view showing one example of case information when information is added; and

FIG. 9 is a view showing an indication example of a screen that sets conditions to determine a case to be similar.

### DETAILED DESCRIPTION OF THE PREFERRED EMBODIMENTS

Hereinafter, preferable embodiments of the present invention are described in detail with reference to accompanying drawings.

### <<System Configuration>>

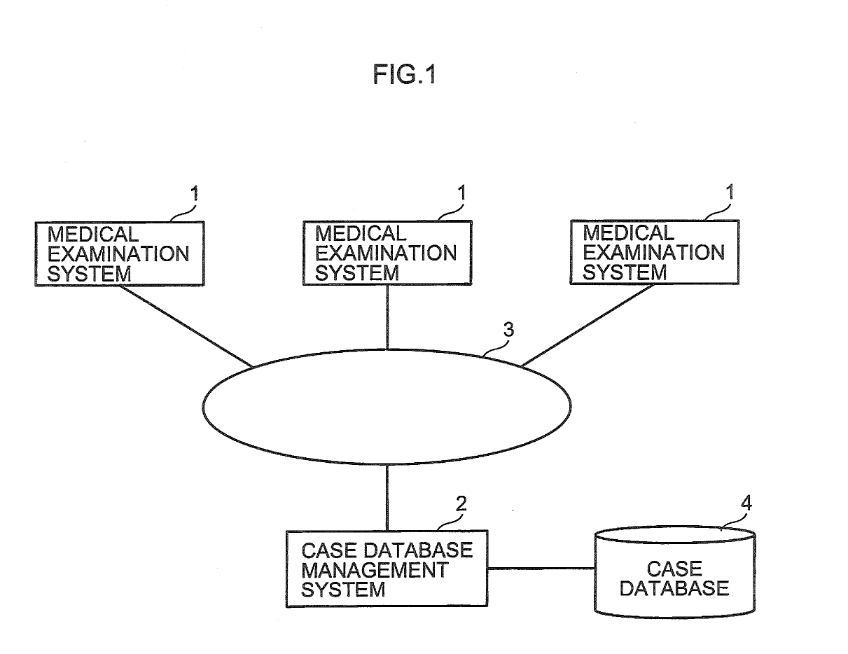

FIG. 1 is a system configuration view showing the schematic configuration of a case management system with the present invention applied thereto.

As shown in the drawing, the case management system mainly includes a medical examination system 1 that generates and manages medical examination information in hospitals and clinics, a case database management system 2 that registers case information into a case database 4 and searches the case database 4 for case information, and a network 3 (Internet line or dedicated line) connected to these systems.

Although the case database 4 is configured to be directly connected to the case database management system 2 in this example, the case database 4 may also be configured to be connected to a local area network 19.

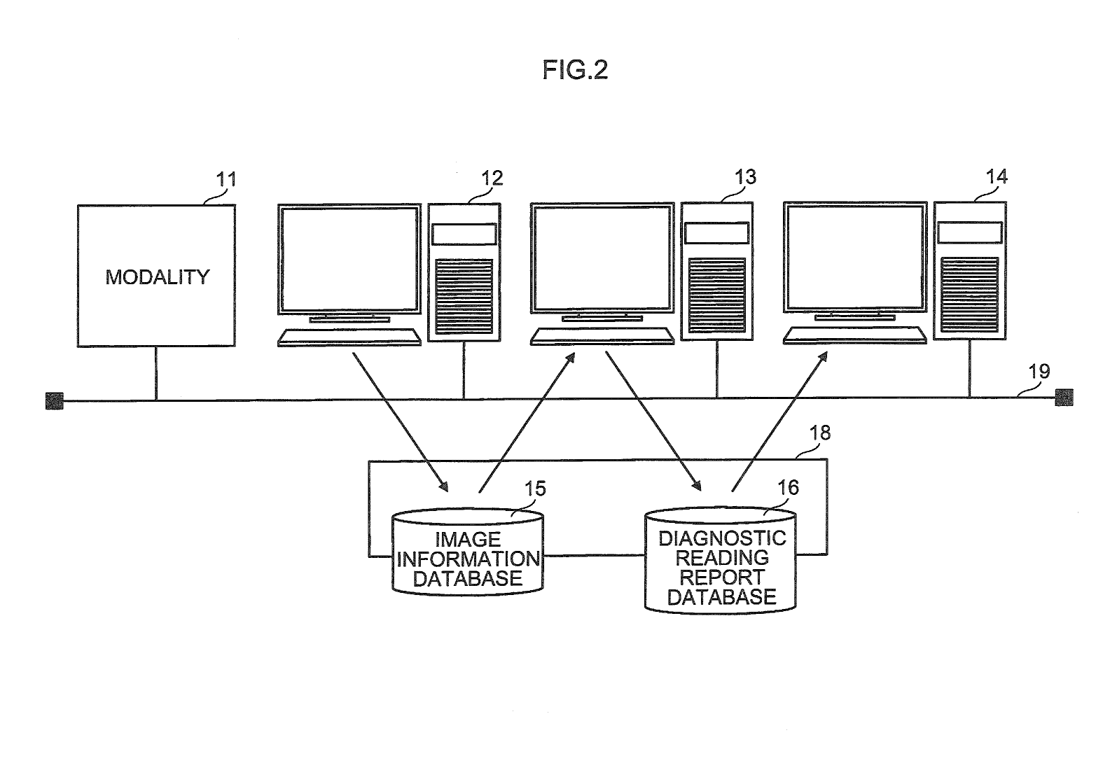

FIG. 2 is a system configuration view showing the schematic configuration of the medical examination system.

As shown in the drawing, the medical examination system 1 includes an imaging device (hereinafter referred to as “modality”) 11, an inspecting engineer workstation 12, a radiologist workstation 13, an examination doctor workstation 14, an image information database 15, a diagnostic reading report database 16, and a database management server (hereinafter referred to as “DBMS (Data Base Management System)”) 18 that manages these three kinds of databases. The respective devices are connected so as to communicate with each other through the local area network 19.

In FIG. 2, the medical examination system 1 is composed of each one device connected to the local area network 19 for the sake of convenience. However, a plurality of and various types of modalities are connected to the local area network 19. Corresponding to the number of inspecting engineers, radiologists, and examination doctors, a plurality of the inspecting engineer workstations 12, the radiologist workstations 13, and the examination doctor workstations 14 are connected thereto.

The modality 11 is a device that takes an image of an object to generate image data and adds attendant information prescribed based on DICOM standard to the image data to generate and output image information.

The modality 11 may be of the type that collectively executes processing ranging from imaging of the object to generation of image data and may also be of the type that includes, as a separate unit, an imaging device that records a taken image onto a record sheet and a reader that reads an image from the record sheet to generate image data. Concrete examples of the modality 11 include X-ray plain radiography devices, as well as CT, MR, PET and ultrasonic photography devices.

The inspecting engineer workstation 12 includes a processor (e.g., a general-purpose computer), one or two high definition displays, and an input device such as a keyboard/mouse. The processor incorporates a software program for aiding operation of the inspecting engineers.

The inspecting engineer workstation 12 receives image information from the modality 11 by the function of the software program incorporated in the processor and indicates image data and the content of attendant information included in the received image information on the display for prompting an inspecting engineer to make a confirmation. The inspecting engineer workstation 12 then transfers the image information confirmed by the inspecting engineer to the DBMS 18 through the local area network 19 and requests registration of the image information into the image information database 15.

The DBMS 18 is made by incorporating a software program, which provides a function of DBMS, in a general-purpose computer with a relatively high throughput. The DBMS 18 stores the data, which is requested to be registered, in a large capacity storage connected to the DBMS 18. When there is a request to access to the registered data, the DBMS 18 extracts and provides the data that matches search conditions. Data may be stored in NAS (Network Attached Storage) and SAN (Storage Area Network) which are connected to the local area network 19.

Once the DBMS 18 receives an image information registration request, the DBMS 18 formats the image information into a database format and registers the formatted image information into the image information database 15.

For example, the image information is managed as XML or SGML data and is made up of image data representing object images and attendant information that includes at least a patient ID (patient number) for identifying the object, an examination number for identifying an examination, and an image number for identifying each image. The attendant information also includes, in addition to those listed above, a unique ID (UID) assigned for every image information, an examination date and examination time when the image information was generated, a type of the modality used in the examination for obtaining the pertinent image information, patient information such as a patient name, age and sex, an examination region (radiographing region), radiography conditions (such as use of contrast media/used pigment, radiation nuclear species, and dose of radiation), and a series number or serial number allotted when a plurality of images are obtained in one examination.

Once the DBMS 18 receives an access request from the radiologist workstation 13 through the local area network 19, the DBMS 18 searches image information registered in the image information database 15 and transmits extracted image information to the radiologist workstation 13 that is a request source.

The radiologist workstation 13, which is a device used for diagnostic reading of an image by a radiologist, includes a processor, one or two high definition displays, and an input device such as a keyboard/mouse. The processor incorporates a software program which provides a function of aiding a diagnosis by the radiologist (e.g., a function of automatically detecting and highlighting potential lesion portions in an image), a function of aiding preparation of diagnostic reading reports, a function of receiving registration of a case into a case database, and a function of receiving access to the cases.

Once an operation is performed to request an access to a diagnostic reading target image and other information for use in a diagnosis, the radiologist workstation 13 transmits an access request to the DBMS 18 and obtains image information on the diagnostic reading target image or information required for the diagnosis. The radiologist workstation 13 indicates the obtained image information on the display and executes such processing as automatic lesion detection processing in response to a request from the radiologist.

The radiologist workstation 13 also indicates on the display a report preparation screen which aids preparation of a diagnostic reading report. The radiologist inputs a text representing findings obtained based on diagnostic reading and the content of the diagnosis according to the indication on the display. The radiologist workstation 13 generates a diagnostic reading report including the inputted information and an image used as a diagnostic reading target (hereinafter referred to as “diagnostic reading target image”). When there are a plurality of diagnostic reading target images, a representative image (hereinafter referred to as “representative image”) which exerted a largest influence over the diagnosis is recorded onto the diagnostic reading report.

The radiologist workstation 13 transfers the generated diagnostic reading report to the DBMS 18 through the local area network 19, and requests registration of the diagnostic reading report into the diagnostic reading report database 16.

Once the DBMS 18 receives the diagnostic reading report registration request, the DBMS 18 formats the diagnostic reading report into a database format and registers the formatted diagnostic reading report into the diagnostic reading report database 16.

For example, the diagnostic reading report is managed as XML or SGML data and includes image data representing a diagnostic reading target image or a representative image, information such as an examination number, a patient ID (patient number), an image number, an examination date (radiography date) and an examination type (modality) which are obtained by referring to the attendant information of the image information at the time of the diagnostic reading of the image, examination region information, findings information, and diagnosis information. Among these, the image data may be a copy of the image data included in image information or may be reduced (thinned) image data made up of pixels fewer than those of the image data included in the image information. The image data may also be link information representing a storage (such as a folder) and a file name of the image data in the image information database 15. The diagnostic reading report preferably contains, together with the image data, coordinate information that indicates a region of interest (ROI) set with respect to the image data during diagnostic reading. The coordinate information indicating the region of interest may not only be recorded onto the diagnostic reading report but also in the attendant information of the image information.

Once an operation is performed to request registration of a case whose diagnostic reading report was prepared or a case whose diagnostic reading report is currently being accessed, the radiologist workstation 13 transmits a registration request to the case database management system 2.

Further, once an operation is performed to request an access to case information, the radiologist workstation 13 transmits to the case database management system 2 a case information access request.

The case database management system 2 executes case registration and search processing in response to the case information registration and access requests from the radiologist workstation 13. A detailed description of this point is described later.

The examination doctor workstation 14, which is a device used by an examination doctor to refer to diagnostic reading reports, includes a processor, one or two high definition displays, and an input device such as a keyboard/mouse. The processor incorporates a software program which provides a function of receiving an access to the diagnostic reading report on an examination target.

Once an operation is performed to request an access to a diagnostic reading report and other information for use in a diagnosis (such as image information attached to the diagnostic reading report), the examination doctor workstation 14 transmits an access request to the DBMS 18.

Once the DBMS 18 receives the access request from the examination doctor workstation 14, the DBMS 18 searches the diagnostic reading reports registered into the diagnostic reading report database 16 and transmits an extracted diagnostic reading report to the examination doctor workstation 14 that is a request source.

The examination doctor workstation 14 receives the transmitted diagnostic reading report and indicates the information on the display.

As described above, once an operation is performed to request registration of a case in the generated diagnostic reading report or a case in the diagnostic reading report which is currently being accessed, the radiologist workstation 13 transmits a registration request to the case database management system 2. Moreover, once an operation is performed to request an access to the case information, the radiologist workstation 13 transmits to the case database management system 2 a request to access to the case information.

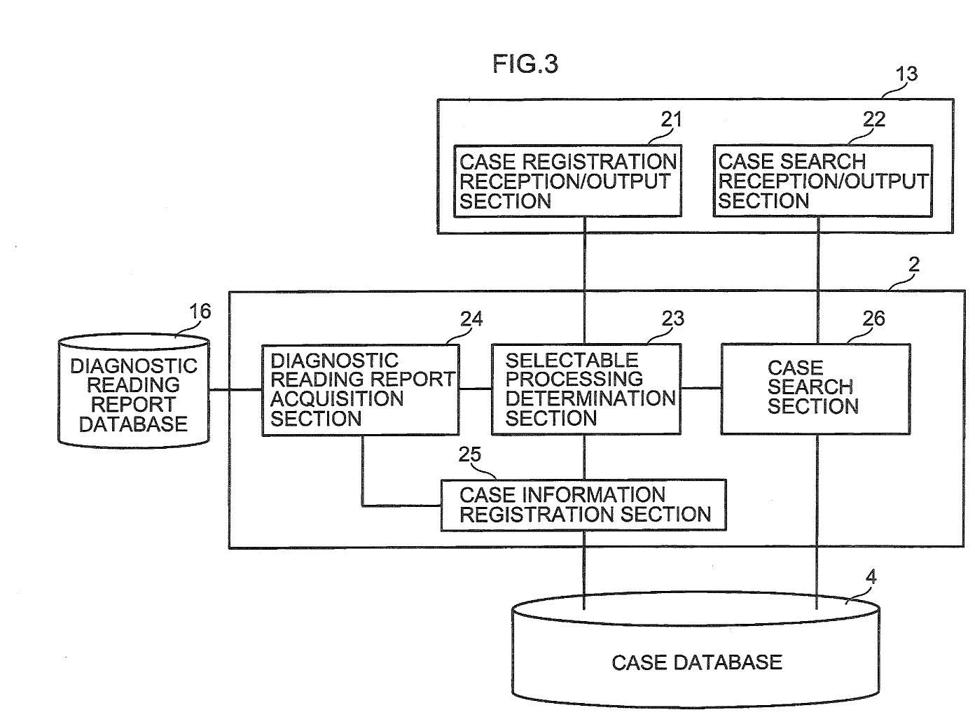

FIG. 3 is a view showing the configuration of the case management system of FIG. 1 with an emphasis being given to functions of case registration and access thereto.

As shown in the drawing, the radiologist workstation 13 includes a case registration reception/output section 21 and a case search reception/output section 22.

The case registration reception/output section 21 receives a case registration request by a user (an operation to request case registration), and instructs the case registration to the case database management system 2. The case registration reception/output section 21 also receives and outputs a response to the registration instruction transmitted from the case database management system 2, i.e., information on processing options selectable in registration and attendant information thereof. Further, the case registration reception/output section 21 receives a selected processing option and instructs the case database management system 2 to execute the received processing.

The case search reception/output section 22 receives a case search request from the user (an operation to request search for a case), and instructs search for the case to the case database management system 2. The case search reception/output section 22 also receives and outputs a result of the instructed search transmitted from the case database management system 2.

The functions of the case registration reception/output section 21 and the case search reception/output section 22 are implemented by incorporating a case registration reception/output program and a case search reception/output program in the processor of the radiologist workstation 13.

The case database management system 2 includes a selectable processing determination section 23, a diagnostic reading report acquisition section 24, a case information registration section 25, and case search section 26, and is configured by incorporating a software program, which provides a function of DBMS, and a software program, which provides functions of the respective sections, in a general-purpose computer with a relatively high throughput.

The selectable processing determination section 23 receives an instruction to register a case from the radiologist workstation 13. The selectable processing determination section 23 determines user selectable processing options regarding the received case, and sends the result to the radiologist workstation 13. The selectable processing determination section 23 also receives a selection result regarding the selectable processing options from the radiologist workstation 13.

The diagnostic reading report acquisition section 24 acquires the diagnostic reading report on a registration target from the diagnostic reading report database 16.

The case information registration section 25 prepares case information on the case to be registered. The case information registration section 25 then registers the prepared case information into the case database 4.

The case search section 26 receives a case search instruction from the radiologist workstation 13. The case search section 26 searches the case database 4 for the received case, and outputs the result to the radiologist workstation 13. The case search section 26 also receives a case search instruction from the selectable processing determination section 23, and searches the case database 4 for the received case. The case search section 26 then outputs the result to the selectable processing determination section 23.

### <<Case Registration Procedures>>

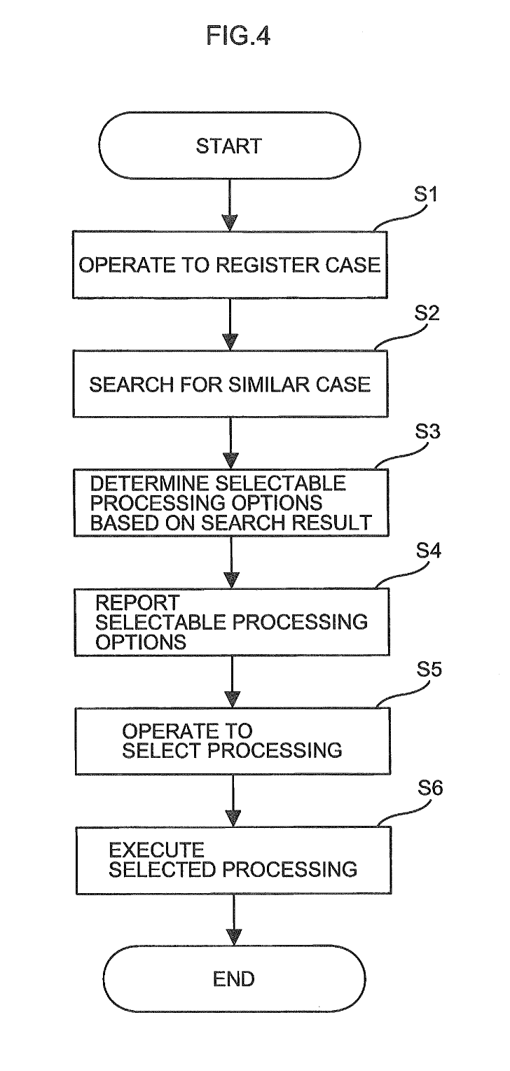

FIG. 4 is a flow chart showing case registration procedures.

When a case registration operation is performed by a user (Step S1), the case registration reception/output section 21 receives a case registration request.

For example, the case registration operation is implemented by instructing case registration to a diagnostic reading report currently indicated on the display of the radiologist workstation 13 with a keyboard/mouse or the like. Therefore, the user first prepares or reads the diagnostic reading report on a case as a registration target and indicates it on the display.

Upon reception of a case registration instruction, the case registration reception/output section 21 specifies a diagnostic reading report on the registration target, and transmits a registration instruction to the case database management system 2.

The registration instruction is received by the selectable processing determination section 23. Upon reception of the registration instruction, the selectable processing determination section 23 acquires the diagnostic reading report as a registration target from the diagnostic reading report database 16. In order to determine whether or not a case that can be determined to be similar to the case of the acquired diagnostic reading report has already been registered, the selectable processing determination section 23 instructs to search for the case to the case search section 26.

The case search section 26 searches the case database 4 in response to the search instruction and extracts a case that can be determined to be similar to the instructed case (Step S2). The case search section 26 then outputs the search result (presence of the similar case and case information on the similar case that can be determined to be similar if extracted) to the selectable processing determination section 23.

It is to be noted that conditions (search conditions) to determine a case to be similar may be set with use of for example, a patient ID, an examination type, an examination region, an examination date (period) or the like. Therefore, when the search conditions are set with the patient ID, the examination type, and the examination region, the case matching all these conditions is determined as a similar case.

The selectable processing determination section 23 acquires the search result of the case that can be determined to be similar from the case search section 26, and determines user selectable processing options based on the search result (Step S3). The user selectable processing options are determined by the presence of the case that can be determined to be similar.

More specifically, if there is no case that can be determined to be similar (pattern A), the selectable processing determination section 23 determines, as the selectable processing options, A1: processing of registering as a new case, and A2: processing of cancelling registration.

If there is a case that can be determined to be similar (pattern B), the selectable processing determination section 23 determines, as the selectable processing options, B1: processing of registering as a new case, B2: adding to an existing case, and B3: processing of cancelling registration.

The selectable processing determination section 23 outputs user selectable processing options determined based on a search result to the radiologist workstation 13 (step S4). At the same time, search result information is outputted to the radiologist workstation 13. More specifically, the selectable processing determination section 23 outputs the presence of a similar case and case information on the similar case that can be determined to be similar, if extracted, to the radiologist workstation 13.

The information on selectable processing options and the attendant information thereof are received by the case registration reception/output section 21 in the radiologist workstation 13. The case registration reception/output section 21 indicates on the display the information on the acquired selectable processing options and the attendant information thereof in a specified format.

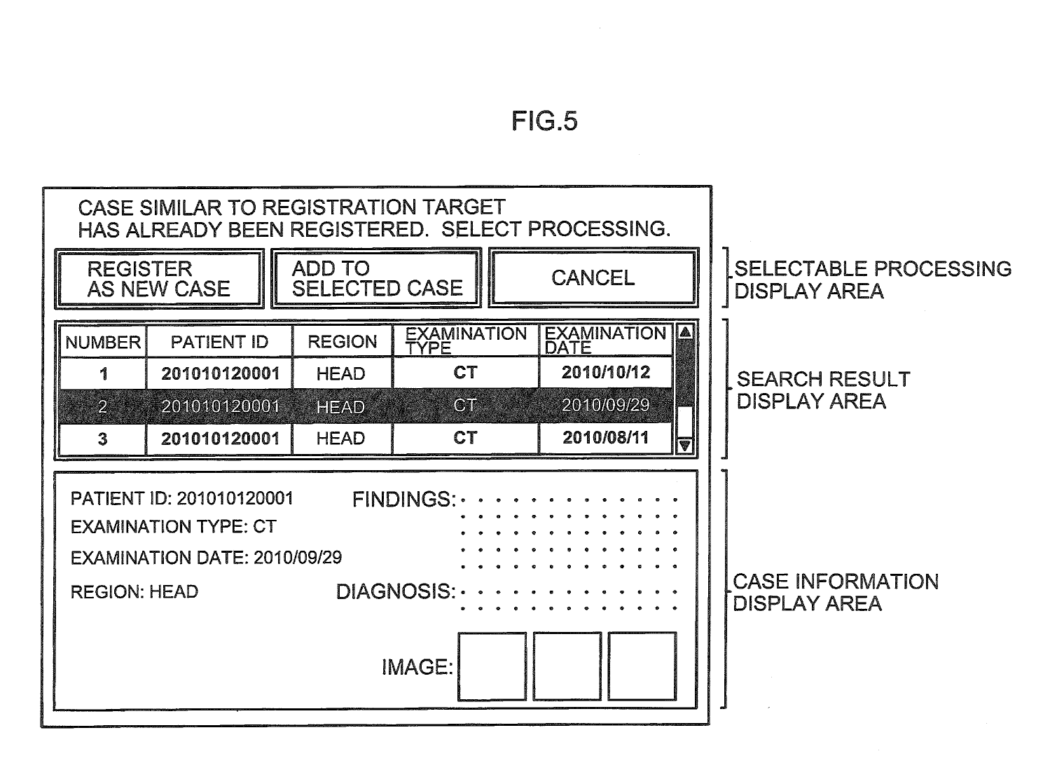

FIG. 5 is a view showing one example of a display indication when there are cases that can be determined to be similar (pattern B).

As shown in the drawing, when there are cases that can be determined to be similar (pattern B), a message to inform that the case that can be determined to be similar has already been registered is indicated on the display together with a message to prompt selection of processing. Indicated on the display are the selectable processing options, a list of retrieved cases (cases retrieved as the case that can be determined to be similar) and details of the cases, i.e., case information.

The selectable processing options are indicated in the form of a button in a specified selectable processing option display area. Therefore, a processing option to be requested can be selected by clicking any one of the buttons.

As described above, when there is a case that can be determined to be similar, there are three selectable processing options: processing of registering as a new case (B1); processing of adding to an existing case (B2); and processing of cancelling registration (B3). Accordingly, three buttons representing the respective processing options are indicated. In the example shown in FIG. 5, a button “Register as new case” is indicated as the button representing the processing of registering as a new case, and a button “Add to selected case” is indicated as the button representing the processing of adding to an existing case. A button “Cancel” is also indicated as the button representing the processing of cancelling registration.

A list of the retrieved cases is indicated in a specified search result display area. In this case, specified information (information of a patient ID, an examination region, an examination type, and an examination date in this example) is extracted from the cases and indicated as a list.

When a plurality of cases that can be determined to be similar are retrieved, all the retrieved cases are indicated. When a display space is limited, the cases may be indicated by being scrolled where necessary.

As for the case information, the case information on a case that is selected out of the listed cases is indicated in a specified case information display area. Therefore, a list of the cases indicated in the search result display area is selectably indicated (selected by being clicked or the like). In the example shown in FIG. 5, the selected case is reversely indicated (a background and characters are displayed in reversed colors) so that the selected case is emphasized.

When a plurality of cases that can be determined to be similar are retrieved, the case information on the case indicated at the top of the search result display area may automatically be indicated in the case information display area. It is also possible to configure so that the case information is indicated in the case information display area only after the user selects the case to be indicated.

When there is only one case that can be determined to be similar, detailed information on the case may automatically be indicated in the case information display area, or case information may be indicated in the case information display area only after the user selects the case indicated in the search result display area.

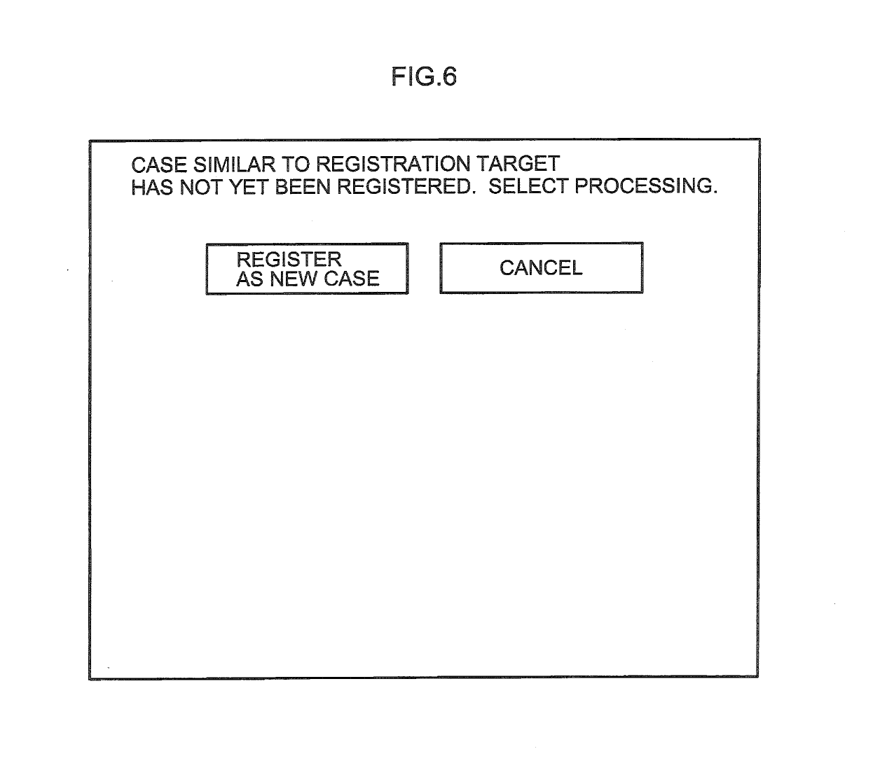

FIG. 6 is a view showing one example of a display indication when there is no case that can be determined to be similar (pattern A).

As shown in the drawing, when there is no case that can be determined to be similar in the case database 4 (pattern A), a message to inform that the case that can be determined to be similar has not been registered is indicated on the display together with a message to prompt selection of processing. The selectable processing options are then indicated.

The selectable processing options are indicated in the form of a button in a specified selectable processing option display area. Therefore, a processing option to be requested can be selected by clicking any one of the buttons.

As described above, when there is no case that can be determined to be similar, there are two selectable processing options: processing of registering as a new case (A1); and processing of cancelling registration (A2), and so two buttons representing the respective processing options are indicated. In the example shown in FIG. 6, a button “Register as new case” is indicated as the button representing the processing of registering as a new case, and a button “Cancel” is indicated as the button representing the processing of cancelling registration.

The user selects a processing option as he/she desires according to the indication on the display (Step S5).

Therefore, when there is no case that can be determined to be similar (pattern A), the button “Register as new case” or the button “Cancel” is clicked to select one of the processing of registering as a new case and the processing of cancelling registration as shown in FIG. 6.

When there is a case that can be determined to be similar (pattern B), any one of the button “Register as new case”, the button “Add to selected case”, and the button “Cancel” is clicked as shown in FIG. 5 to select any one processing option out of processing of registering as a new case, processing of registering by adding to an existing case and processing of cancelling registration.

Once the case registration reception/output section 21 in the radiologist workstation 13 receives a selection of the processing options, the case registration reception/output section 21 instructs execution of the selected processing to the case database management system 2 (Step S6).

That is, when the processing of cancelling registration is selected, the case registration reception/output section 21 instructs execution of the processing of cancelling registration to the case database management system 2. The selectable processing determination section 23 receives this instruction. In this case, processing is ended without execution of registration.

When the processing of registering as a new case is selected, the case registration reception/output section 21 instructs execution of registering as a new case to the case database management system 2. The selectable processing determination section 23 receives this instruction, and instructs registration as a new case to the case information registration section 25.

Once the case information registration section 25 receives the instruction of registration as a new case, the case information registration section 25 acquires a diagnostic reading report from the diagnostic reading report database 16. The case information registration section 25 then generates case information based on the acquired diagnostic reading report, and registers the generated case information into the case database 4.

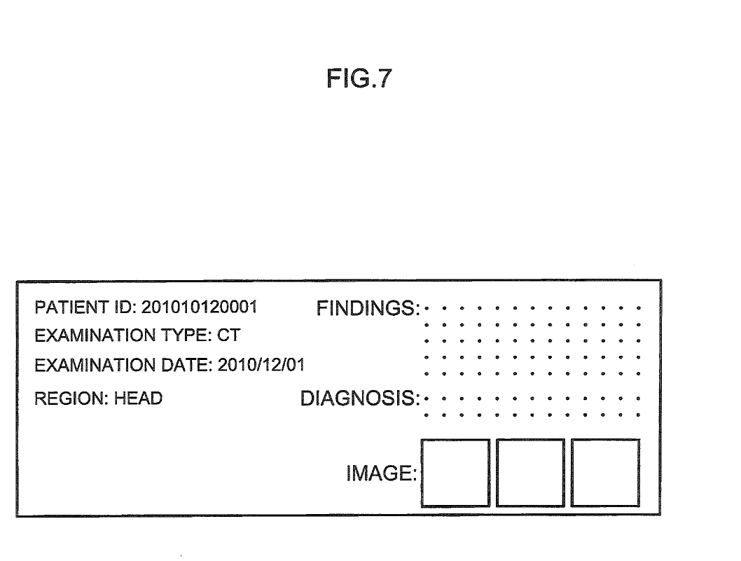

FIG. 7 is a view showing one example of case information generated by the case information registration section. A diagnostic reading report includes information unnecessary as case information. Out of the data included in the diagnostic reading report, the case information registration section 25 first copies the data, such as image data which can be registered as case information without any processing, to a specified area of a memory. Further, a part of the data included in the diagnostic reading report is edited and then placed in a specified area of the memory. As a result, the case information in a specified format is configured on the memory. For example, in the example of FIG. 7, case information is generated which includes information of a patient ID, an examination type, an examination date, an examination region, findings, diagnosis, and an image (case image) subjected to diagnostic reading.

When the processing of registering by adding to an existing case is selected, execution of the processing of adding to an existing case is instructed to the case database management system 2. Upon reception of the instruction, the selectable processing determination section 23 instructs addition to an existing case to the case information registration section 25.

Once the case information registration section 25 receives the instruction of registration by addition to an existing case, the case information registration section 25 acquires a diagnostic reading report on the case, which is to be registered by addition, from the diagnostic reading report database 16. The case information registration section 25 generates case information based on the acquired diagnostic reading report. The case information generated in this section is identical to the case information in the case of being registered as a new case.

Once the case information on the case to be added to an existing case is generated, the case information registration section 25 adds the generated case information to the case information on the existing case (adds to the case information on the existing case which was selected as an addition destination), and updates the case information on the existing case.

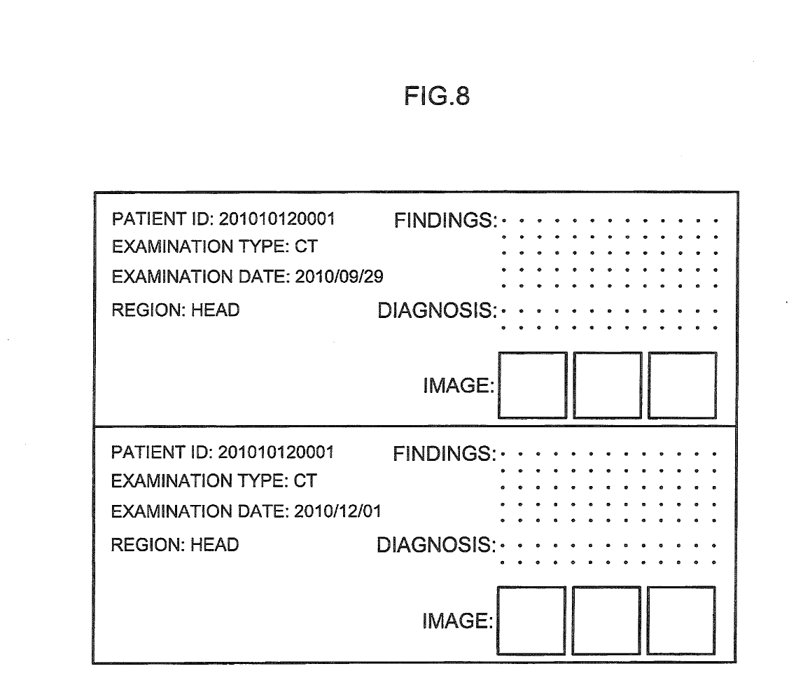

FIG. 8 is a view showing one example of case information on the case to which case information was added. As shown in the drawing, new case information is added to the case information on an existing case, and the case information on the existing case is updated.

According to the case management system of the present embodiment as explained in the foregoing, once an operation is performed to request case registration, the presence of a case that can be determined to be similar is searched first, and a result thereof is reported to a user. As a consequence, it becomes possible to register only the cases truly needed by the user and to thereby construct a reliable database. More specifically, an opportunity to examine the necessity of registration is given, so that only the truly needed cases can be registered. As a result, it becomes possible to construct a reliable database. Moreover, since executable processing options based on the search result are presented to the user, it becomes possible to configure a user-friendly system. Furthermore, when a case that can be determined to be similar is retrieved, case information thereon is also presented, so that the processing to be executed can easily be selected.

It is preferable that criteria for determining cases to be similar are arbitrarily set by the user. In this case, it is preferable, for example, that a specified setting screen is indicated on the display of the radiologist workstation 13 so that setting of the criteria can be implemented in the radiologist workstation 13.

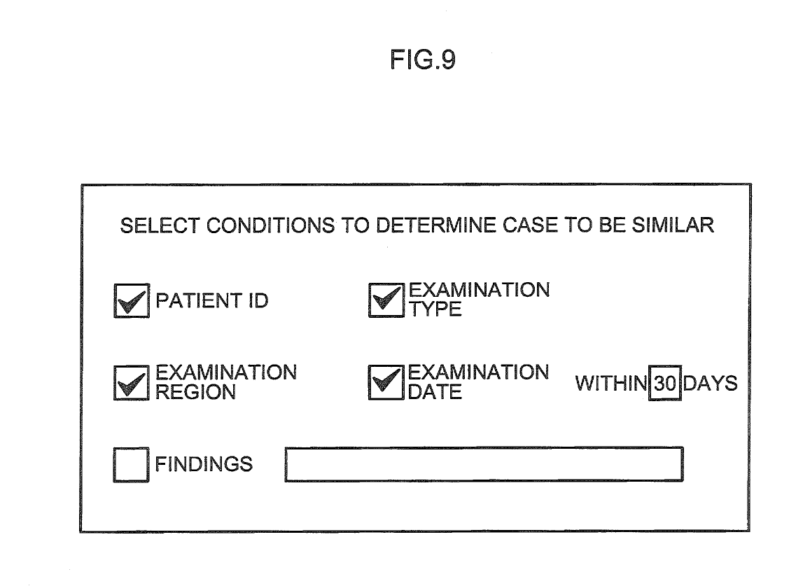

FIG. 9 is a view showing an indication example of a screen that sets conditions to determine a case to be similar. As shown in the drawing, conditions that can be set are indicated as a list. By inputting a check mark to a check box set for each condition, the conditions to determine the case to be similar can arbitrarily be set. Also in the example shown in the drawing, a period of the examination date can be set arbitrarily, and keywords (text) can be inputted as the findings.

Thus, by allowing arbitrary setting of the conditions to determine the case to be similar, the cases truly needed by the user can efficiently be collected and thereby a more reliable database can be constructed.

### <<Use of Case Database>>

A description is now given of a method for using the case database 4 generated as shown above.

The case information registered into the case database 4 is used, for example, as a reference when a radiologist prepares a diagnostic reading report.

As described above, the radiologist workstation 13 includes the case search reception/output section 22. The case search reception/output section 22 receives information inputted from a keyboard or the like as a search query.

Once the search query is set, the case search reception/output section 22 generates a search request in a specified data format including the set search query, and transmits the search request to the case database management system 2.

The case search section 26 in the case database management system 2 searches the case database 4 based on the search query included in the received search request. The case search section 26 then extracts case information including character information similar to the character information included in the search query, or case information including image information similar to the image information included in the search query.

The case search section 26 generates a search result in a specified data format including the extracted case information with an address of a search request source attached thereto, and transmits the search result to the radiologist workstation 13 that is a sender of the search request.

The case search reception/output section 22 in the radiologist workstation 13 receives the search result transmitted from the case database management system 2, and indicates it on the display.

In this case, the case having added case information is indicated on the display in the form including the added case information as shown in FIG. 8. This makes it possible to efficiently obtain the case information on a desired case.

According to the case management system of the present embodiment as described in the foregoing, the presence of a case that can be determined to be similar is searched first at the time of case registration, and a result thereof is reported to a user to inquire of the user the necessity and type of registration. Therefore, it becomes possible to register only the truly needed cases and to thereby construct a reliable database. Moreover, since executable processing options based on the search result are presented to the user, a user-friendly system can be configured. When a case that can be determined to be similar is retrieved, case information thereon is also presented, so that processing to be executed can easily be selected.

In the foregoing embodiments, when a case that can be determined to be similar has already been registered, processing of registering as a new case, processing of registering by adding to an existing case, and processing of cancelling registration are presented as selectable processing options. However, processing options presented as the user selectable processing options are not limited thereto. For example, only one of the processing of registering as a new case and the processing of registering by adding to an existing case may be made selectable, and only one of the processing of registering as a new case and the processing of cancelling registration may also be made selectable. Other processing options may also selectably be presented in addition.

The same applies to the case where there is no case that can be determined to be similar. When there is no case that can be determined to be similar, the system may be configured such that case registration is unconditionally executed without inquiring of the user the necessity of registration.

Moreover, the foregoing embodiments are configured so that operation such as instruction of case registration is performed through the radiologist workstation 13. However, they may be configured so that operation such as instruction of case registration is performed in the case database management system 2.

The radiologist workstation 13 may also be made to implement the functions of the case database management system and the case database.

What is claimed is:

1. A system for managing a case database, comprising:
a case database adapted to have case information, including a case image and diagnostic information on the case image, registered therein per case;
a registration instructing device adapted to instruct registration of case information into the case database;
a similar case search device adapted to search the case database for a case that can be determined to be similar to a case of the case information instructed to be registered by the registration instructing device;
a search result reporting device adapted to report a search result by the similar case search device;
an executable processing reporting device adapted to report executable processing options based on the search result by the similar case search device;
an execution processing selecting device adapted to receive a selection of the executable processing options reported by the executable processing reporting device; and
a processing executing device adapted to execute the processing selected by the execution processing selecting device.

2. The system for managing a case database according to claim 1, wherein
the search result reporting device reports a case retrieved by the similar case search device as the search result.

3. The system for managing a case database according to claim 2, further comprising
a case information output device adapted to output case information on the case retrieved by the similar case search device.

4. The system for managing a case database according to claim 3, further comprising
a case selecting device adapted to select, out of cases reported by the search result reporting device, a case for case information output, wherein
the case information output device outputs case information on the case selected by the case selecting device.

5. The system for managing a case database according to claim 1, wherein
when a case that can be determined to be similar to the case of the case information instructed to be registered by the registration instructing device is retrieved by the similar case search device, the executable processing reporting device reports, as the executable processing options, processing of registering as a new case the case of the case information instructed to be registered by the registration instructing device and processing of cancelling registration of the case of the case information instructed to be registered by the registration instructing device.

6. The system for managing a case database according to claim 1, wherein
when a case that can be determined to be similar to the case of the case information instructed to be registered by the registration instructing device is retrieved by the similar case search device, the executable processing reporting device reports, as the executable processing options, processing of registering as a new case the case of the case information instructed to be registered by the registration instructing device, processing of cancelling registration of the case of the case information instructed to be registered by the registration instructing device, and processing of adding to the case retrieved by the similar case search device the case information instructed to be registered by the registration instructing device.

7. The system for managing a case database according to claim 4, wherein
when a case that can be determined to be similar to the case of the case information instructed to be registered by the registration instructing device is retrieved by the similar case search device, the executable processing reporting device reports, as the executable processing options, processing of registering as a new case the case of the case information instructed to be registered by the registration instructing device, processing of cancelling registration of the case of the case information instructed to be registered by the registration instructing device, and processing of adding to the case retrieved by the similar case search device the case information instructed to be registered by the registration instructing device, and
when the processing of adding to the case retrieved by the similar case search device the case information instructed to be registered by the registration instructing device is selected by the execution processing selecting device, the processing executing device adds to the case selected by the case selecting device the case information instructed to be registered by the registration instructing device.

8. The system for managing a case database according to claim 5, wherein
when a case that can be determined to be similar to the case of the case information instructed to be registered by the registration instructing device is not retrieved by the similar case search device, the executable processing reporting device reports, as the executable processing options, processing of registering as a new case the case of the case information instructed to be registered by the registration instructing device and processing of cancelling registration of the case of the case information instructed to be registered by the registration instructing device.

9. The system for managing a case database according to claim 1, further comprising
a search condition setting device adapted to set conditions for the similar case search device to determine the case to be similar.

10. The system for managing a case database according to claim 1, further comprising:
a case search device adapted to search the case database by using a case image or diagnostic information as a search query; and
an output device adapted to output a case retrieved by the case search device.

11. A method for managing a case database, comprising the steps of:
a step of instructing registration of case information, including a case image and diagnostic information on the case image, into a case database;
a step of searching the case database for a case that can be determined to be similar to a case of the case information instructed to be registered;
a step of reporting a result of the search;
a step of reporting executable processing options based on the result of the search;
a step of receiving selected processing to be executed out of the reported executable processing options; and
a step of executing the selected processing.

12. The method for managing a case database according to claim 11, wherein
in the step of reporting the result of the search, the retrieved case is reported.

13. The method for managing a case database according to claim 12, further comprising
a step of outputting case information on the retrieved case.

14. The method for managing a case database according to claim 13, further comprising
a step of receiving a case selected for case information output out of the reported cases, wherein
in the step of outputting the case information on the retrieved case, case information on the selected case is outputted.

15. The method for managing a case database according to claim 11, wherein
in the step of reporting executable processing options based on the result of the search, processing of registering as a new case the case of the case information instructed to be registered and processing of cancelling registration of the case of the case information instructed to be registered are reported as the executable processing options.

16. The method for managing a case database according to claim 11, wherein
in the step of reporting executable processing options based on the result of the search, processing of registering as a new case the case of the case information instructed to be registered, processing of cancelling registration of the case of the case information instructed to be registered, and processing of adding to the retrieved case the case information instructed to be registered are reported as the executable processing options.

17. The method for managing a case database according to claim 14, wherein
in the step of reporting executable processing options based on the result of the search, processing of registering as a new ease the case of the case information instructed to be registered, processing of cancelling registration of the case of the case information instructed to be registered, and processing of adding to the retrieved case the case information instructed to be registered are reported as the executable processing options, and
in the step of executing the selected processing, if the processing of adding to the retrieved case the case information instructed to be registered is selected as the executable processing, the case information instructed to be registered is added to the case selected for case information output.

18. The method for managing a case database according to claim 15, wherein
in the step of reporting executable processing options based on the result of the search, processing of registering as a new case the case of the case information instructed to be registered by the registration instructing device, and processing of cancelling registration of the case of the case information instructed to be registered by the registration instructing device are reported as the executable processing options.

19. The method for managing a case database according to claim 11, further comprising
a step of setting conditions to determine the case to be similar.
